(19) United States
(12) Patent Application Publication
(10) Pub. No.: US 2022/0243026 A1
(43) Pub. Date: Aug. 4, 2022

(54) FOAM FORMULATION

(71) Applicant: Dow Global Technologies LLC, Midland, MI (US)

(72) Inventor: Masayuki Suzuki, Yokohama (JP)

(21) Appl. No.: 17/597,495

(22) PCT Filed: Aug. 26, 2020
(86) PCT No.: PCT/US2020/047866

§ 371 Date: Jan. 7, 2022

Related U.S. Application Data
(60) Provisional application No. 62/895,082, filed on Sep. 3, 2019.

(51) Int. Cl. C08J 9/12; C08G 18/48; C08G 18/76; C09D 5/02; C09D 175/08; B05D 1/02

(52) U.S. Cl. CPC C08J 9/125; C08G 18/4833; C08G 18/7664; C09D 5/021; C08J 2375/08; B05D 1/02; C08G 2110/0083; C08J 2203/10; C09D 175/08

(57) ABSTRACT

A sprayable water blown low density polyurethane foam-forming formulation including: (A) an isocyanate component; (B) a polyol component, wherein the polyol component includes a surfactant composition; wherein the surfactant composition includes at least one phenol-free secondary alkyl alcohol ethoxylate, and wherein the at least one phenol-free secondary alkyl alcohol ethoxylate is at least one linear alkyl chain phenol-free secondary alcohol ethoxylate; and (C) water; a process for making the above sprayable water blown low density polyurethane foam-forming formulation; and a polyurethane foam made from the above sprayable water blown low density polyurethane foam-forming formulation.

### FIELD

The present invention is related to a sprayable polyurethane (PU) foam-forming formulation; and more specifically, the present invention is related to a sprayable water-blown low-density PU foam-forming formulation containing a surfactant composition including at least one phenol-free secondary alkyl alcohol ethoxylate; and a rigid PU foam made from the sprayable water-blown low-density PU foam-forming formulation.

### BACKGROUND

Polyurethane (PU) foam-forming formulations are well known in the art. Typically, the PU foam-forming formulations are reactive mixtures including a mixture of an isocyanate component (commonly referred to as the isocyanate-side component or the “A-side” component) and an isocyanate-reactive component such as a polyol component (commonly referred to as the polyol-side component or the “B-side” component) with a blend of other compounds such as catalysts, blowing agents, surfactants, flame retardants, and other additives.

Some of the known PU foam-forming formulations are used to prepare an open-cell water blown low density PU rigid foam for rigid foam applications. However, it is not common to use known PU foam-forming formulations in spray applications.

The polyol component (or B-side component) usually contains water as a blowing agent. The content of the water is often >8 wt %, normally from 9.5 wt % to 22 wt %. With known PU foam formulations, the compatibility between water and other ingredients such as polyols, amine catalysts, silicone surfactants and flame retardants is often a problem. And, the mixing efficiency of the polyol-side component with the isocyanate-side component tends to be very low (i.e., not at an optimum level). In particular, the mixing efficiency is low at the point of spraying the mixture of components with, for example, a spray gun used to spray the components. Thus, compatibilizers such as surfactants are often used to aid in optimizing the mixing efficiency of the isocyanate-side (A-side component) and the polyol-side (B-side component). It would be desirable to develop a surfactant composition that can be used as a compatibilizer for a high-water (e.g., >8 wt % water) system to inhibit phase separation between polyol components and water.

For example, nonyl phenol ethoxylate, such as commercially available TERGITOL™ NP9 (having an ethylene oxide (EO) content of from 8 mol to 10 mol EO), is a known surfactant used as a compatibilizer agent for PU foam formulations. However, the nonyl phenol ethoxylate surfactant is considered to be toxic and environmentally undesirable, particularly when the surfactant is to be in contact with water systems. In addition, the probability of the surfactant contacting humans is quite high, particularly when the surfactant is incorporated into a sprayable foam system being applied by an operator using a spray applicator, for example, at a construction site. Thus, the use of nonyl phenol ethoxylate on a global basis is decreasing. It would be desirous to provide a surfactant system that is non-toxic and that still provides an efficient compatibilizing affect when used as a compatibilizer agent in a sprayable PU foam formulation.

Thus, an important ingredient for a PU-based foam-forming formulation for making a sprayable foam-forming formulation would include a non-toxic or less toxic surfactant. However, although various surfactants and mixtures of surfactants other than nonyl-phenol ethoxylate (NPE) are known in the art and are useful for making PU foams, not all surfactants work the same and many of the surfactants have problems. For example, JP06110431B2 discloses an emulsifier formulation, which does not contain an NPE; and JP06110431B2 discloses contacting an isocyanate component with a mixture comprising polyol, water, catalyst and an alkyl alcohol ethoxylate-based emulsifier having a specific average hydrophilic-lipophilic balance (HLB) value of from 10 to 15. The emulsifier (surfactant) taught in JP06110431B2 is useful as a sprayable water polyurethane foam for space-filling; and has the following chemical structure:

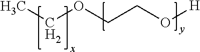

The problem with using the linear alkyl primary alcohol ethoxylate emulsifier disclosed in JP06110431B2 is that the surfactant tends to crystalize at low temperatures. For example, for the case of a linear alkyl alcohol having 11 carbon atoms (C11) with an EO level of 7 mol to 9 mol (which is regarded as an off-set of nonyl phenol ethoxylate with 9 mol EO), the temperature of crystallization is around 14° C. Therefore, to be useful as a compatibilizer agent, a surfactant compound is required to be stable (i.e., no formation of crystallization occurs) in the polyol mixture at a wider temperature range, for example, from 3° C. to 50° C. In addition, the linear alkyl primary alcohol ethoxylates disclosed in the above reference have limited compatibility in the disclosed polyol system having a high water content (e.g., a water content of >8 wt %); and thus, the resulting polyol mixture tends to be hazy, and the components in the polyol mixture tend to separate within a short period of time (e.g. <24 hours). It would be desirous to provide a surfactant system that solves the above stability and compatibility issues.

JP2005075860A discloses manufacturing a lightweight open-cell hard (rigid) polyurethane foam having a high dimensional stability (e.g., no significant shrinkage of the foam occurs). The hard foam is manufactured using water as a blowing agent and a storage-stable polyol composition. JP2005075860A suggests using monol as a surfactant additive in a hard foam-forming system because the monol ingredient exhibits better compatibility than other additives. The monol compound described in JP2005075860A has a chain length of <C11 such as a chain length of 1 carbon atom to 10 carbon atoms (C1-C10) of a monol alkoxylate (ethylene oxide and/or propylene oxide is used). The problem with using the monol compound disclosed in JP2005075860A is that the monol compound has a low melting point. Therefore, the monol compound: (1) does not exhibit good compatibility with other components; and (2) does not have good stability in a polyol mixture component. No other surfactants are taught in the above reference.

U.S. Patent Application Publication No. US20070238800A1 discloses a storage stable isocyanate-reactive component (e.g., a polyol) containing: (1) an aliphatic alcohol ethoxylate in combination with (2) an aliphatic phenol ethoxylate having a polymerized ethylene oxide content of at least 25 mol per equivalent of alcohol or phenol and an HLB value of >17. The storage stable isocyanate-reactive component disclosed in US20070238800A1 is useful for urethane foam and elastomer preparation, producing reactive component, and urethane foam and elastomer. The disadvantage of using the composition taught in US20070238800A1, however, is that the resulting polyol mixture tends to be hazy, and the components in the polyol mixture tend to separate with time (e.g. <3 days).

In view of the above problems experienced with the use of known surfactants, such as nonyl phenol ethoxylate, in PU-based foam-forming formulations for making a sprayable foam, it is desired to provide a surfactant that: (1) is non-toxic (and environmentally acceptable); (2) provides an optimum mixing efficiency; and (3) exhibits other beneficial mechanical and chemical properties.

### SUMMARY

The present invention is directed to a sprayable water blown low density polyurethane (PU) rigid foam-forming formulation including: (A) an isocyanate component; (B) a polyol component, wherein the polyol component includes a novel surfactant composition; and (C) water.

In a broad embodiment, the “sprayable water blown low density PU rigid foam-forming formulation” of the present invention, herein referred and abbreviated to as the “sprayable PU foam-forming formulation” and further abbreviated as the “SPUF formulation”, includes a novel surfactant composition that: (1) is advantageously biodegradable; (2) has a very low aquatic toxicity; and (3) can be easily incorporated into the polyol component of a polyurethane foam-forming formulation to produce a foam article by a spraying method.

In one embodiment, the surfactant composition useful for producing SPUF formulation of the present invention includes at least one phenol-free secondary alkyl alcohol ethoxylate, wherein the at least one phenol-free secondary alkyl alcohol ethoxylate is at least one linear alkyl chain phenol-free secondary alcohol ethoxylate.

In a preferred embodiment, the linear alkyl chain phenol-free secondary alcohol ethoxylate used in the SPUF formulation of the present invention can be, for example, a linear alkyl chain of from 8 carbon atoms to 16 carbon atoms (C8-C16). By “low density” herein, it is meant a density of <20 Kg/m³ in one embodiment; and from 5 Kg/m³ to 20 Kg/m³ in another embodiment.

In another preferred embodiment, the SPUF formulation of the present invention contains, for example, a surfactant composition that comprises a combination of at least two phenol-free secondary alkyl alcohol ethoxylates as follows: (a) a first linear alkyl chain phenol-free secondary alcohol ethoxylate (e.g., SOFTANOL™ 90; available from Nihon Shokubai) which has an EO content of 9 mol and an average HLB value of 13.3; and (b) a second linear alkyl chain phenol-free secondary alcohol ethoxylate (e.g., ECOSURF™ EH6; available from The Dow Chemical Company) which has an EO content of 6 mol and an average HLB of 10.8.

For example, the first linear alkyl chain phenol-free secondary alcohol ethoxylate of the surfactant composition can include a linear alkyl chain of from 10 carbon atoms to 16 carbon atoms (C10-C16) and an EO content of average 9 mol (such as SOFTANOL™ 90); and the second linear alkyl chain phenol-free secondary alcohol ethoxylate can include a linear alkyl chain of from 8 carbon atoms to 12 carbon atoms (C8-C12) and an EO content of average 6 mol such as 2-ethyl hexyl alcohol ethoxylate (e.g., ECOSURF™ EH6). The ratio of the first phenol-free secondary alcohol ethoxylate to the second phenol-free secondary alcohol ethoxylate can be, for example, 50 to 50 in weight.

In another embodiment, the present invention includes a process for producing the SPUF formulation.

In still another embodiment of the present invention is directed to a PU foam made from SPUF formulation.

The novel surfactant composition, which is beneficial for making the SPUF formulation of the present invention, can be used as a replacement for conventional nonyl phenol ethoxylate which is toxic. In addition, the surfactant composition useful in the present invention can be used as a compatibilizer; and when used as a compatibilizer, the surfactant composition exhibits several improvements, including for example: (1) increased compatibility of the surfactant composition mixed with a high water polyol system, (2) increased compatibility at a wide temperature range of from 3° C. to 50° C.; (3) increased storage stability of the polyol mixture system, i.e., without the surfactant composition, the polyol system mixture easily undergoes phase separation; (4) stabilizes the foaming properties with isocyanate in the above temperature range of from 3° C. to 50° C.; (5) good mixing properties between the polyol-side and isocyanate-side components of the SPUF formulation in a spray process; (6) good foam cell structure; and (7) the surfactant composition can be readily used together with a silicone surfactant which contributes to nucleation and foam cell size control.

### DETAILED DESCRIPTION

As used throughout this specification, the abbreviations given below have the following meanings, unless the context clearly indicates otherwise: “=” means “equal to”; @ means “at”; “<” means “less than”; “>” means “greater than”; “<” means “less than or equal to”; “>” means “greater than or equal to”; g=gram(s); mg=milligram(s); kg=kilograms; mol=moles; Kg/m³=kilograms per cubic meter; L=liter(s); mL=milliliter(s); g/L=grams per liter; rpm=revolutions per minute; Mw=molecular weight; m=meter(s); μm=microns: mm=millimeter(s); cm=centimeter(s); min=minute(s); s=second(s); hr=hour(s); ° C.=degree(s) Celsius; MPa=megapascals; W/mK=Watts per meter-Kelvin; ng/(s·m2·Pa)=nanograms per pascal second square meter; mPa·s=millipascals-seconds; kPa=kilopascals; Pa·s/m²=pascals-seconds per meter squared; %=percent, vol %=volume percent; and wt %=weight percent.

All percentages stated herein are weight percentages (wt %), unless otherwise indicated.

Temperatures are in degrees Celsius (° C.), and “ambient temperature” or “room temperature” means between 20° C. and 25° C., unless specified otherwise.

“Phenol-free ethoxylate”, with reference to a surfactant composition, herein means a surfactant composition that contains no, or a minimal amount (e.g., a concentration of 0 wt to 1.0 wt %) of, phenol ethoxylate groups in the backbone structure of an ethoxylate compound, but instead contains aliphatic ethoxylate groups in the backbone structure of an ethoxylate compound.

A “linear alkyl chain” herein means an alkyl chain having >8 carbon atoms (C8) in one embodiment; and from 8 carbon atoms to 15 carbon atoms (C8-C15) in another embodiment.

“Storage-stable” with reference to a composition” is a composition that does not exhibit phase separation. Storage stability of an isocyanate-reactive component such as a polyol component is important to provide a homogeneous material without phase separation, which in turn, provides a final quality product that has uniformity.

In a broad embodiment, the present invention SPUF formulation includes a surfactant composition, wherein the surfactant composition includes, for example, at least one phenol-free secondary alkyl alcohol ethoxylate, wherein the at least one phenol-free secondary alkyl alcohol ethoxylate is at least one linear alkyl chain phenol-free secondary alcohol ethoxylate.

In a preferred embodiment, the surfactant composition includes a mixture of: (a) a first linear alkyl chain phenol-free secondary alcohol ethoxylate; and (b) a second linear alkyl chain phenol-free secondary alcohol ethoxylate. Other optional components can be added to the surfactant composition.

The first linear alkyl chain phenol-free secondary alcohol ethoxylate used for making the surfactant composition of the present invention can include, for example, a linear alkyl chain (C13) secondary alcohol ethoxylate (9 mol EO); and mixtures thereof.

In a preferred embodiment, the first linear alkyl chain phenol-free secondary alcohol ethoxylate useful in the present invention can include commercially available compounds such as SOFTANOL™ 90 (available from Nihon Shokubai); and TERGITOL™ 15-S-9 (available from The Dow Chemical Company), and mixtures thereof.

The chain length of the first linear alkyl chain phenol-free secondary alcohol ethoxylate is from 10 carbon atoms to 16 carbon atoms (C10-C16) in one embodiment, and from 12 carbon atoms to 14 carbon atoms (C12-C14) in another embodiment.

The first linear alkyl chain phenol-free secondary alcohol ethoxylate has an EO content of from 3 mol to 12 mol in one embodiment; from 7 mol to 9 mol in another embodiment; and from 8 mol to 9 mol in still another embodiment.

The first linear alkyl chain phenol-free secondary alcohol ethoxylate has an average HLB value of from 7.9 to 14.5 in one embodiment; from 12.1 to 14.5 in another embodiment; and from 12.1 to 13.3 in still another embodiment.

The amount of the first linear alkyl chain phenol-free secondary alcohol ethoxylate used in the surfactant composition of the present invention can be, for example, from 1 wt % to 15 wt % in one embodiment, from 2 wt % to 15 wt % in another embodiment and from 5 wt % to 10 wt % in still another embodiment based on the total amount of compounds in the surfactant composition.

The second linear alkyl chain phenol-free secondary alkyl alcohol ethoxylate used for making the surfactant composition of the present invention can include, for example, 2-ethyl hexyl alcohol ethoxylate; n-paraffin oxide secondary alcohol ethoxylate; and mixtures thereof.

In another preferred embodiment, the second linear alkyl chain phenol-free secondary alkyl alcohol ethoxylate can include commercially available compounds such as ECOSURF™ H6, TERGITOL™ CA60 and ECOSURF™ EH9, TERGITOL™ CA90 (all available from The Dow Chemical Company); and mixtures thereof.

The second linear alkyl chain phenol-free secondary alkyl alcohol ethoxylate has an EO content of from 3 mol to 14 mol in one embodiment; and from 5 mol to 10 mol in another embodiment; and from 6 mol to 9 mol in still another embodiment.

The second linear alkyl chain phenol-free secondary alkyl alcohol ethoxylate has an average HLB of from 7 to 15 in one embodiment; from 9 to 15 in another embodiment; and from 9 to 13 in still another embodiment.

The amount of the second linear alkyl chain phenol-free secondary alkyl alcohol ethoxylate used in the surfactant composition of the present invention can be, for example from 1 wt % to 15 wt % in one embodiment, from 1 wt % to 10 wt % in another embodiment and from 5 wt % to 10 wt % in still another embodiment based on the total amount of compounds in the polyol component.

Generally, the surfactant including the first linear alkyl chain phenol-free secondary alkyl alcohol ethoxylate, component (a), and the second linear alkyl chain phenol-free secondary alkyl alcohol ethoxylate, component (b), includes a ratio of component (a) to component (b) of, for example, from 1 to 99 in weight in one embodiment, from 25 to 75 in weight in another embodiment, and from 50 to 50 in weight in still another embodiment.

A broad embodiment of a process of producing a surfactant composition for use in making a SPUF formulation useful for forming a PU foam includes, for example, simply thoroughly mixing: the first linear alkyl chain phenol-free secondary alcohol ethoxylate, component (a), described above; the second linear alkyl chain phenol-free secondary alkyl alcohol ethoxylate, component (b), described above; and (c) any optional ingredients to form a surfactant mixture which can be processed via conventional mixing equipment and techniques used for making mixtures. The order or sequence of mixing is not critical.

The components (a)-(c) can be mixed, for example, at a temperature of from 10° C. to 60° C. in one embodiment, from 15° C. to 55° C. in another embodiment, and from 25° C. to 50° C. in still another embodiment. Mixing the components at temperatures below 10° C., can cause the composition to have a high viscosity (e.g., >800 mPa-s). Mixing the components at temperatures above 60° C., can cause water vaporization in the composition which can make it difficult to adjust the final water content of the composition. And, the mixing of the components (a)-(c) can be carried out at any pressure. In one preferred embodiment, for example, the mixing pressure is at atmospheric pressure (i.e., 1.013 25 bar or 1 atm).

Some of the advantageous properties exhibited by the resulting surfactant composition produced according to the above-described process, can include, for example: less foaming can occur during the step of mixing the components even though water and surfactant are mixed vigorously. The degree of foaming is determined by visual observation during the mixing step.

In a broad embodiment, the SPUF formulation of the present invention includes a reactive mixture of the following components: (A) at least one isocyanate component comprising at least one polyisocyanate compound; (B) at least one polyol component including the surfactant composition described above; and (C) water. In one embodiment, the polyol component of the SPUF formulation includes, for example, (Bi) at least one polyol compound, (Bii) the surfactant composition described above; (Biii) at least one silicone compound; (Biv) at least one flame retardant; (By) at least one amine catalyst; and the water component (C) is added to the mixture of compounds of the polyol component (B) or as a separate additive to the SPUF formulation. In a preferred embodiment, the water is added to the polyol component (B).

Other optional components can be added to the SPUF formulation if desired. The above mixture of components forms the resulting reactive SPUF formulation that, once mixed together, for example using a spraying device, eventually react to form a polyurethane foam product.

The isocyanate component, component (A), of the present invention can include one or more polyisocyanate compounds including for example a mixture of diphenylmethane diisocyanate; isomers and homologues of diphenylmethane diisocyanate (e.g., two more isomers such as 2,2′- and 2,4′-isomer); and 4,4′-methylene diphenyl diisocyanate (MDI); larger molecular weight oligomers of MDI such as polymeric MDI or crude MDI; and mixtures thereof.

In one preferred embodiment, the polyisocyanate compound can include, for example, a polymeric MDI, and typically a low viscosity grade MDI for providing the reactive mixture a low initial viscosity at room temperature. For example, the viscosity of the polymeric MDI at 25° C. is from 50 mPa·s to 2,000 mPa·s in one embodiment; from 50 mPa·s to 400 mPa·s in another embodiment; and from 100 mPa·s to 250 mPa·s in still another embodiment. The viscosity of the polyisocyanate compound is measured by the process described in ASTM D445.

In another preferred embodiment, the polyisocyanate compound can include commercially available compounds such as PAPI™ 27 and PAPI™ 135 (both available from The Dow Chemical Company); and mixtures thereof.

Typically, the amount of polyisocyanate compound used in the reactive composition of the present invention when the composition is used in a spray foam application, can be, for example, at a 1 to 1 ratio in volume between the polyisocyanate compound and the polyol compound.

As aforementioned, the polyol component, component (B), includes a mixture of several compounds including, for example, (Bi) at least one polyol compound; (Bii) the surfactant composition described above; (Biii) at least one silicone compound; (Biv) at least one flame retardant; and (By) at least one amine catalyst; and (Bvi) water.

The polyol component of the present invention can include, for example, (Bi) at least one or more polyol compounds including for example polyoxy propylene oxyethylene polyol; ethylene oxide capped polyoxy propylene polyol; polyoxy propylene oxyethylene monol; tetramethylene ether glycol; polyester polyol; polyoxy butylene polyol; polyether polyester copolymer; and mixtures thereof.

In a preferred embodiment, the polyol compounds can include, for example, sucrose initiated polyoxypropylene polyol; glycerine initiated polyoxypropylene polyol; ethylene diamine initiated polyol, and the like; and mixtures thereof.

In another preferred embodiment, the polyol compound can include commercially available compounds such as VORANOL™ 4701 Polyol, VORANOL™ 4240, VORANOL™ EP1900, VORANOL™ 360, VORANOL™ 446, VORANOL™ 482, VORANOL™ 490, VORANOL™ 640, VORANOL™ 800, VORANOL™ 391, VORANOL™ CP1055, VORANOL™ 8010G, VORANOL™ 2070, VORANOL™ 8595, VORANOL™ 1000LM, VORANOL™ 2000LM, VORANOL™ WD2104 (all available from The Dow Chemical Company); and mixtures thereof.

As aforementioned, in a preferred embodiment, a 1 to 1 ratio in volume between the polyisocyanate compound and the polyol compound is used in the reactive composition of the present invention when the composition is used in a spray foam application.

The surfactant composition used in the polyol component is the surfactant composition described above.

The amount of surfactant composition used in the polyol component of the present invention can be, for example, from 1 wt % to 15 wt % in one embodiment, from 5 wt % to 14 wt % in another embodiment and from 8 wt % to 12 wt % in still another embodiment.

The water used in the present invention as a separate additive, component (C), or as an additional additive in component (B), can include, for example, potable water; distilled water; deionized water; or mixtures thereof. And, the amount of water when used in the polyol component (B) of the present invention can be, for example, from 5 wt % to 20 wt % in one embodiment and from 8 wt % to 20 wt % in another embodiment.

Grafted copolymers which consist of a polydimethylsiloxane backbone and poly(ethylene oxide-co-propylene oxide) pendant groups can be used as a surfactant to stabilize the bubbles in flexible polyurethane foam.

The flame retardant used in the present invention can include, for example, tris (1-chloro-2-propyl) phosphate (TCPP). Other flame retardants commonly used in polyurethane foam can also be used.

Amine catalysts play an important role in the composition of the present invention, not only in the control and balance between the gelling and blowing reactions, but also in the optimization of the foam properties and the curing speed during the foam formation. Tertiary amines either alone or in combination with organo-tin catalyst can be used as catalysts in the manufacture of polyurethane foams.

In addition to the above components (A), (B) and (C) in the reactive mixture, the reactive mixture of the present invention may also include other additional optional compounds or additives; and such optional compounds may be added to the mixture with any of the components (A), (B) or (C) or as a separate addition. The optional additives or agents that can be used in the present invention can include one or more various optional compounds known in the art for their use or function. For example, the optional additives, agents, or components can include internal mold release agents, lubricants, other flame retardants, other surface-active additives, pigments, dyes, UV stabilizers, plasticizers, and fungistatic or bacteriostatic substances, external release agents, internal release agents, and mixtures thereof. External release agents, such as silicone oils, can be used instead of, or in addition to, internal release agents.

The amount of optional compound used, when added to the reactive mixture of the present invention, can be for example, from 0 wt % to 5 wt % in one embodiment, from 0.1 wt % to 2 wt % in another embodiment and from 0.1 wt % to 1 wt % in still another embodiment.

A broad embodiment of a process of producing a SPUF formulation useful for forming a PU foam includes, for example, simply thoroughly mixing the following components: (A) a polyisocyanate; (B) a polyol, (C) water and (D) optional ingredients to form a reactive mixture which can be processed via conventional mixing equipment and techniques used for making the SPUF formulation.

The reactants can be mixed, for example, at a temperature of from 5° C. to 60° C. in one embodiment, from 15° C. to 55° C. in another embodiment, and from 25° C. to 50° C. in still another embodiment. And, the mixing of the reactants can be carried out at any pressure including, for example, atmospheric pressure.

One of the beneficial properties of the SPUF formulation is the formulation's viscosity. For example, the viscosity of the formulation at 25° C. is from 100 mPa·s to 1,000 mPa·s in one embodiment; from 150 mPa·s to 500 mPa·s in another embodiment, and from 150 mPa·s to 300 mPa·s in still another embodiment. The viscosity of the SPUF formulation can be measured by the process described in ASTM D445.

The foam product of the present invention is produced by spraying the reactive mixture described above onto the surface of a substrate. In a spray process, for example, the components described above are injected into a spray device with an actuating means, such as a spray gun, which mixes the components into one stream; and when the actuating means of the spray gun is actuated, the stream exits the spray gun in the form of a reactive mixture that begins to react, i.e., begins to form a foam, as the reactive mixture contacts the surface of a substrate.

The SPUF formulation (reactive mixture) can be sprayed using a conventional mixing and spraying device such as a spray gun. The mixing and spraying of the components using a spray gun can be carried out, for example, at a temperature of from −10° C. to 45° C. in one embodiment and from −5° C. to 45° C. in another embodiment. The spraying of the SPUF formulation can be carried out throughout the four seasons of a calendar year, i.e., from winter to summer. However, spraying the SPUF formulation under too cold of a temperature (i.e., <−10° C.), the adhesion of the sprayed SPUF formulation to the sprayed substrate tends to be weak, so delamination can occur. On the other hand, spraying the SPUF formulation in too hot of a temperature (i.e., >45° C.), the foam reactivity of the sprayed SPUF formulation will be too fast and the resulting foam can be coarser than desired.

The mixing and spraying of the components of the SPUF formulation can be carried out, for example, at a pressure of from 3 MPa to 18 MPa in one embodiment and from 6 MPa to 10 MPa in another embodiment. Below a spray pressure of 3 MPa, the discharge flow rate of the spray is too low and thus, can take a longer period of time to complete the work.

The process of producing a PU foam product is carried out by reaction. When carrying out the process of the present invention, the reaction components of the SPUF formulation, that is, the polyisocyanate, isocyanate-reactive compounds, surfactant, blowing agent, catalyst, and any other additives and auxiliaries commonly used in PU foam-forming formulations; are reacted as the reactive mixture is being delivering to the surface of a substrate using, for example, a resin spray gun.

In a general embodiment, the process for producing a polyurethane foam product of the present invention includes a low-pressure spraying method. The process includes spraying the reactive mixture at room temperature.

In a general embodiment, the process for producing a polyurethane foam product includes, for example, the steps of (I) mixing: (a) a polyisocyanate; (b) a polyol; and any other optional components, if desired; to form a reactive mixture; (II) after mixing the components described above to form a reactive mixture, spraying the reactive mixture onto the surface of a desired substrate; and (III) allowing the resulting sprayed reactive mixture to react under the spray conditions to form a polyurethane foam product.

Some of the advantageous properties exhibited by the resulting foam product produced according to the above described process, can include, for example: (1) the thermal conductivity of the foam product is generally below 0.040 W/(mK) as measured according the process described in JIS A1412; (2) the moisture permeability of the foam product is generally 30 ng/(s·m2·Pa) as measured according the process described in JIS K7225; and (3) the combustibility is improved such that combustion time of the foam product is within 120 s and the extent of combustion is not more than 60 mm as measured according the process described in JIS A9511.

The polyurethane foam product produced by the process of the present invention can be used, for example, in insulation applications for commercial buildings and residential housing, noise abatement applications, vibration abatement applications, and harshness abatement applications for studio rooms.

### EXAMPLES

The following examples are presented to further illustrate the present invention in detail but are not to be construed as limiting the scope of the claims. Unless otherwise indicated, all parts and percentages are by weight.

Various terms and designations used in the Inventive Examples (Inv. Ex.) and the Comparative Examples (Comp. Ex.) which follow are explained hereinbelow:

“EO” stands for ethylene oxide.

“PO” stands for propylene oxide.

“Mw” stands for molecular weight based on weight.

“TCPP” stands for tris chloropropyl phosphate.

“MDI” stands for diphenylmethane diisocyanate, isomers and homologues, and 4,4′-methylene diphenyl diisocyanate.

Various ingredients, components, additives, or raw materials used in the Inv. Ex. and the Comp. Ex) which follow are explained hereinbelow in Table I:

TABLE I
Raw Materials

| Material | Technical Feature | Provided By: |
|---|---|---|
| SOFTANOL ™70 | Linear alkyl chain (C12-14) | Nihon |
| | (average 7 mol EO) secondary alcohol ethoxylate | Shokubai |
| SOFTANOL ™90 | Linear alkyl chain (C12-14) | Nihon |
| | (average 9 mol EO) secondary alcohol ethoxylate | Shokubai |
| SOFTANOL ™120 | Linear alkyl chain (C12-14) | Nihon |
| | (average 12 mol EO) secondary alcohol ethoxylate | Shokubai |
| ECOSURF ™EH6 | 2 ethyl hexyl alcohol ethoxylate | Dow |
| | (6 mol EO) | |
| DOWANOL ™EPh6 | Phenol ethoxylate (6 mol EO) | Dow |
| TERGITOL ™NP9 | Nonyl phenol ethoxylate (9 mol EO) | Dow |
| ECO-36 | Castor oil ethoxylate (36 mol EO) | Dow |
| PAPI ™27 | Polymeric MDI | Dow |

### Test Methods

### Hand Foaming Test

A hand foaming test for various samples is carried out as follows: A polyol premix is mixed with a polymeric MDI, PAPI™ 27, at 3,000 rpm for 3 s. The mixing ratio of polyol/isocyanate is as follows: polyol 28 g/isocyanate 32 g in a 1,000 mL plastic cup.

### Observed Reactivity

The requirements for a hand foaming test, including cream time, rise time and foam height, are summarized in Table II.

TABLE II

| Property | Result |
|---|---|
| Cream time, s | 3-7 |
| Rise time, s | 12-16 |
| Foam height, mm | 250-300 |

As for a spray foam application, the cream time should be faster like 3 s to 7 s; otherwise, the sprayable mixture will start sagging (i.e., the sprayable liquid drips or runs down on the surface of a vertical wall). The rise time is important and should be fast, for example, within 12 s to 16 s. Delaying rise time would lead to an irregular foam thickness and can often cause delamination. The foam height relates to the foam's density. If the density of the foam is too low (e.g., <5 Kg/m³), the foam's insulation performance can be too low; and the foam's mechanical properties may be poor i.e., too fragile, weak strength and easily delaminated. If the density of the foam is too high (e.g., >20 Kg/m³), the high density of the foam is unnecessary and uneconomical.

### Compatibility Check (Visual)

A visual check of liquid mixture samples by ranking the mixture from “clear” to “hazy”. “Clear” means good compatibility. “Hazy” means phase separation and bad compatibility.

Drop-in-replacement of TERGITOL™ NP9 with other surfactants in the formulation.

### Foam Appearance Check (Visual)

The cell structure and appearance of the foam is carried out by visual inspection of the foam. The appearance of the foam is checked at 25° C. and 3° C.

The results of the above tests are described in Table III.

TABLE III
Formulations and Test Results

| | | Inventive Example | | | Comparative Example | | |
|---|---|---|---|---|---|---|---|
| | | 1 | 2 | 3 | A | B | C |
| Component | Ingredient | (wt %) | (wt %) | (wt %) | (wt %) | (wt %) | (wt %) |
| Polyol | Polyol | 55 | 55 | 55 | 55 | 55 | 55 |
| Formulation | Water | 10 | 10 | 10 | 10 | 10 | 10 |
| | Amine catalyst | 8 | 8 | 8 | 8 | 8 | 8 |
| | Silicone surfactant | 2 | 2 | 2 | 2 | 2 | 2 |
| | Flame retardant | 15 | 15 | 15 | 15 | 15 | 15 |
| | SOFTANOL ™ 90 | 7.5 | 5 | 2.5 | 0 | 10 | 0 |
| | ECOSURF ™ EH6 | 2.5 | 5 | 7.5 | 0 | 0 | 10 |
| | DOWANOL ™ EPh6 | 0 | 0 | 0 | 0 | 0 | 0 |
| | ECO-36 | 0 | 0 | 0 | 0 | 0 | 0 |
| | SOFTANOL ™ 70 | 0 | 0 | 0 | 0 | 0 | 0 |
| | SOFTANOL ™ 120 | 0 | 0 | 0 | 0 | 0 | 0 |
| | TERGITOL ™ NP 9 | 0 | 0 | 0 | 10 | 0 | 0 |
| | Total | 100 | 100 | 100 | 100 | 100 | 100 |
| Polyol Formulation Visual Check | | | | | | | |
| Compatibility: Appearance at 25° C. by | | Clear | Clear | Clear | Clear | Clear | Hazy |
| visual observation | | | | | | | |
| Compatibility: Appearance at 3° C. by | | Clear | Clear | Clear | Clear | Clear | Hazy |
| visual observation | | | | | | | |
| Isocyanate Component | | PAPI ™ | PAPI ™ | PAPI ™ | PAPI ™ | PAPI ™ | PAPI ™ |
| | | 27 | 27 | 27 | 27 | 27 | 27 |
| Index | | 63 | 63 | 63 | 63 | 63 | 62.5 |
| Foam Properties | | | | | | | |
| Foam Properties: mixing at 3,000 rpm; | | Good | Good | Good | Good | Good | Good |
| mixing for 3 s; using a volumetric ratio of | | slightly | fine cell | fine cell | fine cell | large cell | fine cell |
| polyol to isocyanate of 1 to 1 | | large cell | | | | | |
| Reactivity: | Cream time, s | 5.2 | 5.8 | 5.2 | 4.8 | 5.2 | 5.2 |
| | Rise time, s | 15.2 | 14.2 | 15.5 | 15.3 | 15.4 | 15.3 |
| | Foam height, mm | 260 | 260 | 270 | 260 | 265 | 265 |

| | | Comparative Example | | | |
|---|---|---|---|---|---|
| | | D | E | F | G |
| Component | Ingredient | (wt %) | (wt %) | (wt %) | (wt %) |
| Polyol | Polyol | 55 | 55 | 55 | 55 |
| Formulation | Water | 10 | 10 | 10 | 10 |
| | Amine catalyst | 8 | 8 | 8 | 8 |
| | Silicone surfactant | 2 | 2 | 2 | 2 |
| | Flame retardant | 15 | 15 | 15 | 15 |
| | SOFTANOL ™ 90 | 0 | 0 | 0 | 0 |
| | ECOSURF ™ EH6 | 0 | 0 | 0 | 0 |
| | DOWANOL ™ EPh6 | 10 | 0 | 0 | 0 |
| | ECO-36 | 0 | 10 | 0 | 0 |
| | SOFTANOL ™ 70 | 0 | 0 | 10 | 0 |
| | SOFTANOL ™ 120 | 0 | 0 | 0 | 10 |
| | TERGITOL ™ NP 9 | 0 | 0 | 0 | 0 |
| | Total | 100 | 100 | 100 | 100 |
| Polyol Formulation Visual Check | | | | | |
| Compatibility: Appearance at 25° C. by | | Clear | Hazy and | Clear | Clear |
| visual observation | | | Separation | | |
| Compatibility: Appearance at 3° C. by visual | | Clear | Hazy and | Some | Clear |
| observation | | | Separation | Haziness | |
| Isocyanate Component | | PAPI ™ 27 | PAPI ™ 27 | PAPI ™ 27 | PAPI ™ 27 |
| Index | | 62.5 | 62.5 | 63 | 63 |
| Foam Properties | | | | | |
| Foam Properties: mixing at 3,000 rpm; | | Good | Good | Not Good | Not Good |
| mixing for 3 s; using a volumetric ratio of | | fine cell, some | fine cell | fine cell | coarse cell |
| polyol to isocyanate of 1 to 1 | | shrinkage | | | |
| Reactivity: | Cream time, s | 5.3 | 5.2 | 5.4 | 5.2 |
| | Rise time, s | 14.3 | 15.8 | 14.4 | 11.9 |
| | Foam height, mm | 280 | 290 | 230 | 240 |

### Comparative Examples A and C-E—Formulation Samples

A first set of samples of various liquid mixtures of foam-forming formulations were placed in a clear container (glass jar) and lined up for a visual check of the compatibility of the components in the mixture at a temperature of 25° C.; and a second set of samples of various liquid mixtures of foam-forming formulations were placed in a clear glass jar and lined up for a visual check of the compatibility of the components in the mixture at a temperature of 3° C. The results of the visual observation of the samples were as follows:

The formulation of Comparative Example A used TERGITOL™ NP9 as a surfactant; and the formulation exhibited good compatibility at 3° C. and at 25° C.

The formulation of Comparative Example D used DOWANOL™ EPh6 as a surfactant; and exhibited good compatibility at 3° C. and at 25° C.

The formulation of Comparative Example C used ECOSURF™ EH6 as a surfactant; and exhibited a hazy appearance at 3° C. and at 25° C.

The formulation of Comparative Example E used ECO-36 as a surfactant; and exhibited a hazy appearance at 3° C. and at 25° C.

### Comparative Examples B, F and G—Formulation Samples

A first set of samples of various liquid mixtures of foam-forming formulations were placed in a container (glass jar) and lined up for a visual check of the compatibility of the components in the mixture at a temperature of 25° C.; and a second set of samples of various liquid mixtures of foam-forming formulations were placed in a clear glass jar and lined up for a visual check of the compatibility of the components in the mixture at a temperature of 3° C. The results of the visual observation of the samples were as follows:

The formulation of Comparative Example F used SOFTANOL™ 70 as a surfactant; and the formulation exhibited good compatibility at 3° C. and at 25° C.

The formulation of Comparative Example B used SOFTANOL™ 90 as a surfactant; and the formulation exhibited good compatibility at 25° C., but appeared a little hazy at 3° C.

The formulation of Comparative Example G used SOFTANOL™ 120 as a surfactant; and the formulation exhibited a hazy appearance at 3° C. and at 25° C.

### Examples 1-3—Formulation Samples

A first set of samples of various liquid mixtures of SPUF formulations were placed in a container (glass jar) and lined up for a visual check of the compatibility of the components in the mixture at a temperature of 25° C.; and a second set of samples of various liquid mixtures of SPUF formulations were placed in a clear glass jar and lined up for a visual check of the compatibility of the components in the mixture at a temperature of 3° C. The results of the visual observation of the samples were as follows:

The SPUF formulation of Inventive Example 3 used a mixed surfactant of SOFTANOL™ 70 and ECOSURF™ EH6 at a ratio of SOFTANOL™ 70/ECOSURF™ EH6 of 25/75; and the SPUF formulation exhibited good compatibility 25° C., but appeared a little hazy at 3° C.

The SPUF formulation of Inventive Example 2 used a mixed surfactant of SOFTANOL™ 70 and ECOSURF™ EH6 at a ratio of SOFTANOL™ 70/ECOSURF™ EH6 of 50/50; and the SPUF formulation exhibited good compatibility at 3° C. and at 25° C.

The SPUF formulation of Inventive Example 1 used a mixed surfactant of SOFTANOL™ 70 and ECOSURF™ EH6 at a ratio of SOFTANOL™ 70/ECOSURF™ EH6 of 75/25; and the SPUF formulation exhibited a hazy appearance at 3° C. and at 25° C.

### Comparative Examples A and C-E—Foam Samples

A set of various foam samples formed in a container (jar) were lined up for a check of the reactivity of the foam structure including cream time, rise time, foam height, and foam cell structure (visual); the foam samples being made from liquid mixtures of foam-forming formulations described above. The foam samples were as follows:

The foam sample produced using the formulation of Comparative Example A (TERGITOL™ NP9 used as a surfactant) was a good foam with good reactivity and a sufficient height.

The foam sample produced using the formulation of Comparative Example C (ECOSURF™ EH6 used as surfactant) showed that ECOSURF™ EH6 provided a foam with a very similar foaming profile with that of TERGITOL™ NP9.

The foam sample produced using the formulation of Comparative Example D (DOWANOL™ EPh6 used as surfactant) exhibited a little faster rise time than the foam sample of Comparative Example A. Although the formulation exhibited good mixing because of the low viscosity of the polyol premix, a small amount of shrinkage of the foam occurred.

The foam sample produced using the formulation of Comparative Example E (ECO-36 used as a surfactant) exhibited a different foaming profile. The touch feeling (tactility) of the foam was harder than the foam sample of Comparative Example A probably because the formulation had a functionality of approximately 3.

### Comparative Examples A, B, F and G—Form Samples

A set of various foam samples formed in a container (jar) were lined up for a check of the reactivity of the foam structure including cream time, rise time, foam height, and foam cell structure (visual); the foam samples being made from liquid mixtures of foam-forming formulations described above. The foam samples were as follows:

The foam sample produced using the formulation of Comparative Example F (SOFTANOL™ 70 used as a surfactant) exhibited a similar reactivity, but a lower foam height, compared the foam sample using TERGITOL™ NP9 as a surfactant.

The foam sample produced using the formulation of Comparative Example B (SOFTANOL™ 90 used as a surfactant) exhibited a similar reactivity and foam height with that of the foam sample using TERGITOL™ NP9 as a surfactant, but the foam cell size of the foam sample was a little coarser than that of the foam sample using TERGITOL™ NP9 as a surfactant.

The foam sample produced using the formulation of Comparative Example G (SOFTANOL™ 120 used as a surfactant) exhibited a faster reactivity because of the foam sample's lower foam height than Comparative Example A. The foam cell structure was coarse.

The foam sample produced using the formulation of Comparative Example A (TERGITOL™ NP9 used as a surfactant) was used as a reference foam sample.

### Examples 1-3—Foam Samples

A set of various foam samples formed in a container (jar) were lined up for a check of the reactivity of the foam structure including cream time, rise time, foam height, and foam cell structure (visual); the foam samples being made from liquid mixtures of the SPUF formulations described above. The foam samples were produced using the following SPUF formulations:

The SPUF formulation of Inventive Example 3 used SOFTANOL™ 70/ECOSURF™ EH6=25/75 as the surfactant.

The SPUF formulation of Inventive Example 2 used SOFTANOL™ 70/ECOSURF™ EH6=50/50 as the surfactant.

The SPUF formulation of Inventive Example 1 used SOFTANOL™ 70/ECOSURF™ EH6=75/25 as the surfactant.

All of the foam samples described above exhibited a good appearance, similar reactivity, and similar foam height.

The foam samples made from the SPUF formulations of Inventive Examples 1, 2, and 3 exhibit good compatibility, good reactivity and good foam height when compared to a foam sample made from the formulation of Comparative Example A which used TERGITOL™ NP9 as a surfactant.

It has been found that the higher the SOFTANOL™ 90 ratio is, the larger is the foam cell size.

The foam sample made from the formulation of Comparative Example A (TERGITOL™ NP9 used as the surfactant) showed good compatibility, good reactivity and good foam height. Although TERGITOL™ NP9 is a good surfactant, TERGITOL™ NP9 is regarded as a reproduction toxicity concerning material. Therefore, any remnants of the resulting sprayed foams, using TERGITOL™ NP9 as a surfactant, are not discarded into sewage systems. On the other hand, spray applicators potentially inhale TERGITOL™ NP9 or its foam mist during construction. This potential exposure to the spray applicators can pose a health risk to the spray applicators. Spray applicators do not always use adequate protective equipment to prevent the spray applicators from inhaling the spray.

The foam sample made from the formulation of Comparative Example B (SOFTANOL™ 90 used as the surfactant) showed a larger cell size while compatibility was good.

The foam sample made from the formulation of Comparative Example C (ECOSURF™ EH6 used as the surfactant) showed bad compatibility such as a hazy appearance while showing good reactivity and good foam height.

The foam sample made from the formulation of Comparative Example D (DOWANOL™ EPh6 used as the surfactant) showed good compatibility; however, the foam sample exhibited some foam shrinkage. Inhalation toxicity may also be a potential undesirable issue for the spray application of this foam.

The foam sample made from the formulation of Comparative Example E (ECO-36 used as the surfactant) showed bad compatibility.

The foam sample made from the formulation of Comparative Example F (SOFTANOL™ 70 used as the surfactant) showed relatively good compatibility; however, the foam sample made from the formulation of Comp. Ex. F had a lower foam height than Comparative Example A. Providing a foam with a lower foam height can lead to a poor foaming efficiency of the spray application.

The foam product of made from the formulation of Comparative Example G (SOFTANOL™ 120 used as the surfactant) showed good compatibility; however, the foam cell of the foam product was coarse.

Except for the above-described foam sample made from a formulation containing a combination of ECOSURF™ EH6 and SOFTANOL™ 90 as the surfactant, attempts to make a desired foam sample having good properties from formulations containing other combinations of surfactant (e.g., ECOSURF™ EH6 and SOFTANOL™ 70, SOFTANOL™ 120, DOWANOL™ EPh6) were tried but were unsuccessful because a coarse cell of PU foam was formed and/or the resulting foam-forming formulation exhibited a bad compatibility (hazy appearance).

### Other Embodiments

One embodiment of the present invention includes a surfactant composition for use in producing a water blown low density polyurethane sprayable foam-forming formulation includes at least one phenol-free secondary alkyl alcohol ethoxylate, wherein the at least one secondary alkyl alcohol ethoxylate is at least one linear alkyl chain phenol-free secondary alcohol ethoxylate.

The above surfactant composition used to produce the water blown low density polyurethane sprayable foam-forming formulation has good mixing properties with a polyol component and an isocyanate component. Also, the above surfactant composition o is advantageously non-toxic.

The above surfactant composition including a mixture of at least two linear alkyl chain phenol-free secondary alcohol ethoxylates; the surfactant composition including a first linear alkyl chain phenol-free secondary alcohol ethoxylate having an ethylene oxide content of 9 mol and an average hydrophilic-lipophilic balance of 13.3; and the surfactant composition including a second linear alkyl chain phenol-free secondary alcohol ethoxylate having an ethylene oxide content of 6 mol and an average hydrophilic-lipophilic balance of 10.8.

The above surfactant composition includes a ratio of the first linear alkyl chain phenol-free secondary alcohol ethoxylate to the second linear alkyl chain phenol-free secondary alcohol ethoxylate is a ratio of 50 to 50 in weight.

Another embodiment of the present invention includes a water blown low density polyurethane sprayable foam-forming formulation comprising (A) at least one isocyanate component; and a (B) at least one polyol component, wherein the at least one polyol component includes the above surfactant composition.

The at least one polyisocyanate component of the above formulation is polymeric MDI such as PAPI™ 27; and the concentration of the at least one polyisocyanate component is at about 100 wt %.

The at least one polyol component of the above formulation is a polyether polyol, a polyester polyol, or mixture thereof; and the concentration of the at least one polyol component is, for example, from 40 wt % to 60 wt % in one embodiment.

The above water blown low density polyurethane sprayable foam-forming formulation including the surfactant composition can be used to provide a foam product with a fine foam cell structure

What is claimed is:

1. A sprayable water blown low density polyurethane foam-forming formulation comprising:
(A) an isocyanate component;
(B) a polyol component, wherein the polyol component includes a surfactant composition; wherein the surfactant composition includes at least one phenol-free secondary alkyl alcohol ethoxylate, and wherein the at least one phenol-free secondary alkyl alcohol ethoxylate is at least one linear alkyl chain phenol-free secondary alcohol ethoxylate; and
(C) water.

2. The formulation of claim 1, wherein the surfactant composition is compatible with a polyol component containing a high-water content of from 8 weight percent to 22 weight percent.

3. The formulation of claim 1, wherein the surfactant composition is compatible with a polyol component at a temperature range of from 3° C. to 50° C.; and provides a polyol mixture with a storage stability such that the polyol component does not produce phase separation at a temperature range of from 3° C. to 50° C.

4. The formulation of claim 1, wherein the at least one linear alkyl chain phenol-free secondary alcohol ethoxylate is a mixture of at least two different linear alkyl chain phenol-free secondary alcohol ethoxylates; and wherein the mixture includes a first phenol-free secondary alcohol ethoxylate having an ethylene oxide content of 9 mol and an average hydrophilic-lipophilic balance of 13.3; and wherein the mixture includes a second phenol-free secondary alcohol ethoxylate having an ethylene oxide content of 6 mol and an average hydrophilic-lipophilic balance of 10.8.

5. The formulation of claim 4, wherein the first alkyl chain phenol-free secondary alcohol ethoxylate has a linear alkyl chain of from 12 carbon atoms to 14 carbon atoms; and
wherein the second alkyl chain phenol-free secondary alcohol ethoxylate is 2-ethyl hexyl alcohol ethoxylate.

6. A process for producing a sprayable water blown low density polyurethane foam-forming formulation comprising mixing:
(A) an isocyanate component;
(B) a polyol component, wherein the polyol component includes a surfactant composition; wherein the surfactant composition includes at least one phenol-free secondary alkyl alcohol ethoxylate, and wherein the at least one phenol-free secondary alkyl alcohol ethoxylate is at least one linear alkyl chain phenol-free secondary alcohol ethoxylate; and
(C) water.

7. A process for producing a polyurethane foam comprising the steps of:
(I) spraying the formulation of claim 1 onto the surface of a substrate; and
(II) as the formulation contacts the surface of the substrate from step (II), allowing the formulation to react to form a polyurethane foam.

8. A polyurethane foam made from the sprayable water blown low density polyurethane foam-forming formulation of claim 1.
